(19) United States
(12) Patent Application Publication
(10) Pub. No.: US 2009/0271477 A1
(43) Pub. Date: Oct. 29, 2009

(54) DIGITAL PHOTO FRAME FRAMEWORK CONTROLLED BY COMPUTER AND SYNCHRONOUSLY UPDATED WITH REMOTE SERVER

(75) Inventor: NICHOLAS David FOTHERGILL-ZITTRER, Toronto (CA)

Correspondence Address: Wang Law Firm, Inc., 4989 Peachtree Parkway,, Suite 200, Norcross, GA, 30092, US

(73) Assignee: HUVEUR TECHNOLOGIES INC., Taichung City (TW)

(21) Appl. No.: 12/428,549

(22) Filed: Apr. 23, 2009

(30) Foreign Application Priority Data
Apr. 23, 2008 (TW) 097206974

(51) Int. Cl. G06F 15/16

(52) U.S. Cl. 709/203

(57) ABSTRACT

A digital photo frame framework controlled by a computer and synchronously updated with a remote server comprises a digital photo frame; a computer that is connected with the digital photo frame and has a network connection device, and is provided therein with operating software for generating an identification code and a user interface; an intermediate server that has a user database for storing the setting information related to a user and communicating the corresponding information on the remote server such that when the computer is communicated to the intermediate server by the operating software, the intermediate server and the remote server can be automatically connected and correspond to each other.

### BACKGROUND OF THE INVENTION

(a) Field of the Invention The present invention relates to a digital photo frame, and more particularly to a digital photo frame framework controlled by a computer and synchronously updated with a remote server.

(b) Description of the Prior Art

With the development of modern technology, the display technology that offers the features of compactness, lightweight and low power consumption is becoming gradually popular. A digital photo frame comprised of a display can store multiple photographs, and can rapidly replace the photograph to be displayed without printing out the photograph, thereby eliminating the printing of photographs and allowing the user to replace photographs randomly. These are the effects which a traditional photo frame cannot achieve.

Because network technology is flourishing, there are currently a lot of spaces that are provided by professional suppliers on the network for online users to store their own data, photographs or films in the network spaces. However, a photo frame now on the market does not have the function of connecting the Internet, so it cannot be synchronously updated with the storage space on the network. Therefore, there is a need for improvement.

Furthermore, how to rapidly integrate various kinds of information on the network and transmit them to the storage unit of the digital photo frame is also a problem the present invention seeks to solve.

### SUMMARY OF THE INVENTION

The primary objective of the present invention is to provide a digital photo frame framework controlled by a computer and synchronously updated with a remote server, which has the effects of enabling the digital photo frame to be synchronously updated with the remote server, and rapidly integrating various kinds of information on the network and then transmitting them back to the digital photo frame.

To achieve the foregoing objective, the present invention provides a digital photo frame framework controlled by a computer and synchronously updated with a remote server, comprising:

a digital photo frame that has a display section, a storage portion and a connection port;

a computer that is connected with the connection port of the digital photo frame and has a network connection device for connecting the network, and is provided therein with operating software for generating an identification code and a user interface; and

an intermediate server that has a user database for storing the setting information related to a user and communicating the corresponding information on the remote server such that when the computer is communicated to the intermediate server by the operating software, the intermediate server and the remote server can be automatically connected and correspond to each other, and the intermediate server can read the identification code generated by the operating software and can be connected with the predetermined remote server according to the setting of the user database, and the required information on the remote server is transmitted back to the computer through the intermediate server, and the required information is then stored in the storage portion of the digital photo frame via the operating software.

### BRIEF DESCRIPTION OF THE DRAWINGS

FIG. 1 is a schematic view showing a framework of the present invention.

FIG. 2 is a schematic flow chart showing the operation of the present invention.

### DETAILED DESCRIPTION OF THE PREFERRED EMBODIMENTS

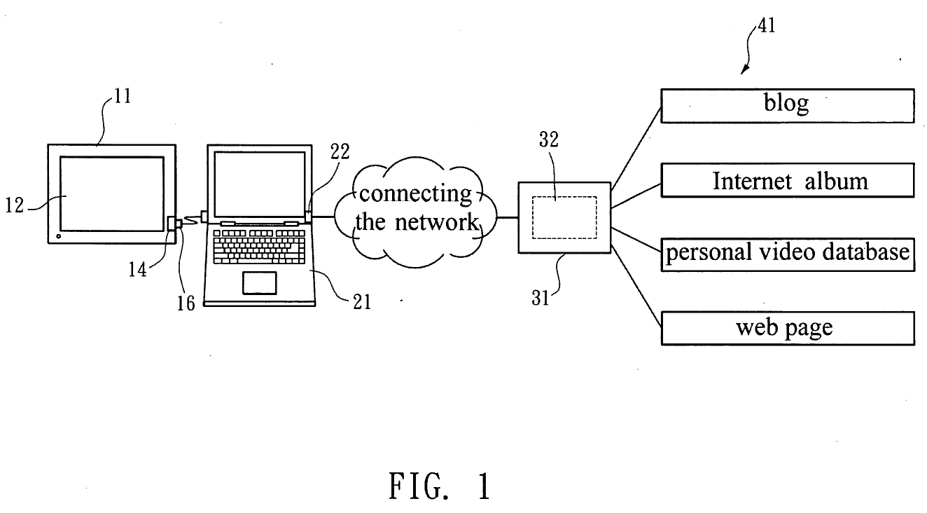

First, referring to FIG. 1, this figure shows a construction of a preferred embodiment according to the present invention. This construction is to be considered in all respects only as illustrative and not restrictive.

A digital photo frame framework controlled by a computer and synchronously updated with a remote server according to the present invention is principally comprised of a digital photo frame 11, a computer 21 and an intermediate server 31, wherein:

The digital photo frame 11 has a display section 12, a storage portion 14 and a connection port 16. The storage portion 14 is used to store pictures or other digital data, and the display section 12 can display the pictures or other digital data stored in the storage portion 14. The connection port 16 is a USB connection port for engaging with a USB interface of a computer peripheral device so as to transmit power and data signals.

The computer 21 has a USB interface corresponding to the connection port 16 of the digital photo frame 11, whereby the computer is connected with the connection port 16 of the digital photo frame 11. The computer 21 has a network connection device 22 for connecting the network. The network connection device 22 can be a wired network connector, and the wired network connector 22 can be a telecommunications transmitter and receiver for the Internet or telecommunication networks. Similarly, the network connection device 22 can also be a telecommunications transmitter and receiver of a wireless network connector. The computer 21 is provided therein with operating software for generating an identification code and a user interface.

The intermediate server 31 has a user database 32 for setting information about more than one user. The user database 32 is used to store the setting information related to a user and communicate the corresponding information on the remote server 41 such that when the computer 21 is communicated to the intermediate server 31 by the operating software, the intermediate server 31 and the remote server 41 can be automatically connected and correspond to each other. The intermediate server 31 is a small gateway controller, a network router, or a data presentation device for reading the identification code generated by the operating software. The user database 32 can contain the identity information related to more than one user and the corresponding websites, ISPs, network gateways, the data addresses of servers or hard disks, names, identification numbers, passwords, channel codes, etc. set by users themselves so as to facilitate the connection and verification when the intermediate server 31 is communicated with the remote server 41.

Furthermore, the intermediate server 31 can be connected with the predetermined remote server 41 according to the setting of the user database 32, and the required information on the remote server 41 is transmitted back to the computer 21 through the intermediate server 31, and the required information is then stored in the storage portion 14 of the digital photo frame 11 via the operating software.

The remote server 41 can be a storage device of a network server provided for an enterprise or an individual by a general website, or a storage device managed by a server, and the storage device can be one of a network storage space, a blog, an Internet album, or a personal video database.

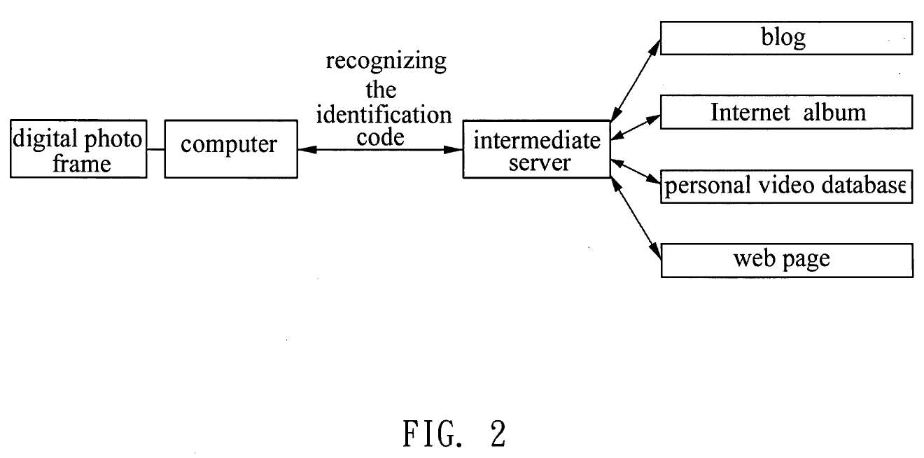

Next, referring to FIG. 2, when in use, the present invention allows the digital photo frame 11 and the computer 21 to be connected with each other through the connection port 16, and the computer 21 is connected with a foreign network via the network connection device 22. At this time, the operating software of the computer 21 provides the user interface through the computer 21, and communicates to the intermediate server 31. After the intermediate server 31 determines that the identification code is correct, the operator can select the remote server 41 to be connected and the digital data to be downloaded from the options on the user interface. Subsequently, the intermediate server 31 will automatically access one item or multiple items of the digital data on different remote servers 41 according to the operator setting, and store it or them in the storage portion 14 of the digital photo frame 11 via the computer 21. In doing so, the digital photo frame 11 according to the present invention has the effect of enabling itself to be synchronously updated with the remote server 41, and can rapidly integrate the digital data provided by the remote server 41 and transmit it to the storage portion 14 of the digital photo frame 11 through the action of the operating software and the intermediate server 31.

As concluded from the above, it will be apparent to those skilled in the art that the present invention can indeed achieve the foregoing purpose, and the application for a patent for invention is duly filed accordingly.

I claim:

1. A digital photo frame framework controlled by a computer and synchronously updated with a remote server, comprising:
a digital photo frame that has a display section, a storage portion and a connection port;
a computer that is connected with the connection port of the digital photo frame and has a network connection device for connecting the network, and is provided therein with operating software for generating an identification code and a user interface; and
an intermediate server that has a user database for storing the setting information related to a user and communicating the corresponding information on the remote server such that when the computer is communicated to the intermediate server by the operating software, the intermediate server and the remote server are automatically connected and correspond to each other, and the intermediate server reads the identification code generated by the operating software and is connected with the predetermined remote server according to the setting of the user database, and the required information on the remote server is transmitted back to the computer through the intermediate server, and the required information is then stored in the storage portion of the digital photo frame via the operating software.

2. The digital photo frame framework controlled by a computer and synchronously updated with a remote server as claimed in claim 1, characterized in that: the intermediate server sets information about more than one user.

3. The digital photo frame framework controlled by a computer and synchronously updated with a remote server as claimed in claim 1, characterized in that: the network connection device is a wired network connector, and the wired network connector is a telecommunications transmitter and receiver for the Internet or telecommunication networks.

4. The digital photo frame framework controlled by a computer and synchronously updated with a remote server as claimed in claim 1, characterized in that: the network connection device is a telecommunications transmitter and receiver of a wireless network connector.

5. The digital photo frame framework controlled by a computer and synchronously updated with a remote server as claimed in claim 1, characterized in that: the remote server is a storage device, or a storage device managed by a server.

6. The digital photo frame framework controlled by a computer and synchronously updated with a remote server as claimed in claim 5, characterized in that: the storage device of the remote server is one of a network storage space, a blog, an Internet album, or a personal video database.

7. The digital photo frame framework controlled by a computer and synchronously updated with a remote server as claimed in claim 1, characterized in that: the remote server is a network server provided for an enterprise or an individual by a general website.
